(19) United States
(12) Patent Application Publication
(10) Pub. No.: US 2009/0245779 A1
(43) Pub. Date: Oct. 1, 2009

(54) Mirror moving device and imaging apparatus

(75) Inventor: Masahiro Negita, Aichi (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/381,516

(22) Filed: Mar. 12, 2009

(30) Foreign Application Priority Data
Mar. 14, 2008 (JP) P2008-065577

(51) Int. Cl. G03B 19/12; G02B 26/08

(52) U.S. Cl. 396/358; 359/223.1

(57) ABSTRACT

A mirror moving device has a mirror configured to change an optical path of an imaging apparatus. The device includes a movable unit having the mirror, a moving mechanism capable of changing an orientation of the mirror between a first position and a second position, and a positioning member configured to be in contact with a predetermined region of the movable unit when the mirror is made to be in the first position, whereby the mirror is positioned in the first position. The predetermined region and the positioning member are magnetic bodies, at least one thereof being magnetized as a permanent magnet. A magnetic attraction acting between the predetermined region and the positioning member when the mirror is in the first position is smaller than a motive force acting on the predetermined region when the mirror in the first position is moved so as to be in the second position.

### CROSS-REFERENCE TO RELATED APPLICATIONS

The present application claims priority from Japanese Patent Application No. JP 2008-065577, filed in the Japanese Patent Office on Mar. 14, 2008, the entire content of which is incorporated herein by reference.

### BACKGROUND OF THE INVENTION

1. Field of the Invention

The present invention relates to a technique for a mirror moving device including a mirror with which the optical path of an imaging apparatus is changed.

2. Description of the Related Art

In general, single-lens reflex cameras (imaging apparatuses) each include a mirror box (mirror moving device) configured as a so-called quick return mirror capable of moving into and retracting from the optical path of an imaging lens. The mirror box houses a mirror unit including a main mirror and a sub-mirror capable of moving (changing the orientation) between a blocking position in which the mirrors are in the optical path and a retracted position in which the mirrors are off the optical path. The mirror unit is positioned so as to be in the blocking position by being brought into contact with a stopper (positioning member).

When the mirror unit in the retracted position is moved so as to be in the blocking position, the mirror unit is stopped suddenly by bumping into the stopper. This causes the mirror unit to bounce, or to vibrate slightly. Before the bouncing stops, it is difficult to perform accurate focus detection (length measurement) with, for example, a phase difference autofocus (AF) sensor configured to receive light from an object reflected by the sub-mirror.

To suppress such bouncing of the mirror unit, Japanese Unexamined Patent Application Publication No. 6-175223 discloses a technique in which bouncing of a mirror unit is stopped quickly by utilizing magnetic attraction of an electromagnet, as the stopper, provided in a camera.

### SUMMARY OF THE INVENTION

In the technique disclosed in Japanese Unexamined Patent Application Publication No. 6-175223, however, use of the electromagnet is accompanied by addition of an electrical circuit or the like for supplying current to the electromagnet, making the entire configuration of the camera complicated and preventing reduction of the size and weight of the camera.

In light of the above, it is desirable to provide a technique for a mirror moving device having a simple configuration and capable of quickly stopping the vibration of a mirror occurring when the mirror bumps into a positioning member by which the mirror that is moved is positioned so as to be in a predetermined position.

According to a first embodiment of the present invention, a mirror moving device has a mirror with which an optical path of an imaging apparatus is changed. The device includes a movable unit provided with the mirror, a moving mechanism capable of changing an orientation of the mirror on the movable unit between a first position and a second position, and a positioning member configured to be in contact with a predetermined region of the movable unit when the mirror is made to be in the first position, whereby the mirror is positioned in the first position. The predetermined region and the positioning member are magnetic bodies, at least one of the predetermined region and the positioning member being magnetized as a permanent magnet. A magnetic attraction acting between the predetermined region and the positioning member when the mirror is in the first position is smaller than a motive force acting on the predetermined region when the mirror in the first position is moved so as to be in the second position.

According to a second embodiment of the present invention, an imaging apparatus includes a movable unit provided with a mirror with which an optical path is changed, a moving mechanism capable of changing an orientation of the mirror on the movable unit between a first position and a second position, and a positioning member configured to be in contact with a predetermined region of the movable unit when the mirror is made to be in the first position, whereby the mirror is positioned in the first position. The predetermined region and the positioning member are magnetic bodies, at least one of the predetermined region and the positioning member being magnetized as a permanent magnet. A magnetic attraction acting between the predetermined region and the positioning member when the mirror is in the first position is smaller than a motive force acting on the predetermined region when the mirror in the first position is moved so as to be in the second position.

According to the first and second embodiments of the present invention, the vibration of the mirror occurring when the movable unit bumps into the positioning member by which the mirror that is moved from the second position is positioned so as to be in the first position can be stopped quickly with a simple configuration.

### BRIEF DESCRIPTION OF THE DRAWINGS

FIG. 1 shows the external configuration of an imaging apparatus 1 according to an embodiment of the present invention;

FIG. 2 shows the external configuration of the imaging apparatus 1;

FIG. 3 is a longitudinal sectional view of the imaging apparatus 1;

FIG. 4 shows a mirror unit MR in a mirror-up position;

FIG. 5 is a perspective view showing major elements in a mirror box 103;

FIG. 6 is a side view showing the major elements in the mirror box 103;

FIG. 7 is an enlarged view of a part enclosed by a dashed-line circle VII in FIG. 5; and

FIG. 8 is a diagram for describing an effect produced by a magnet plate PM and a stopper Sb.

### DESCRIPTION OF THE PREFERRED EMBODIMENTS EXTERNAL CONFIGURATION OF IMAGING APPARATUS

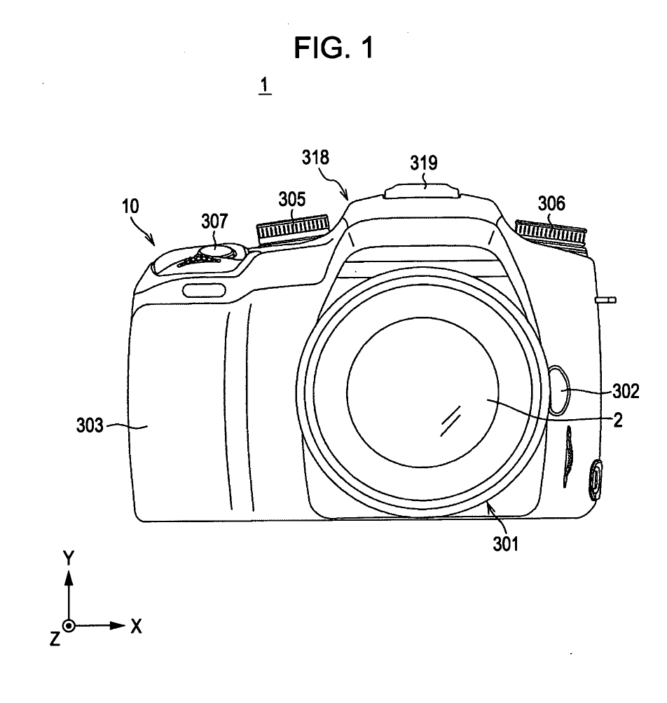

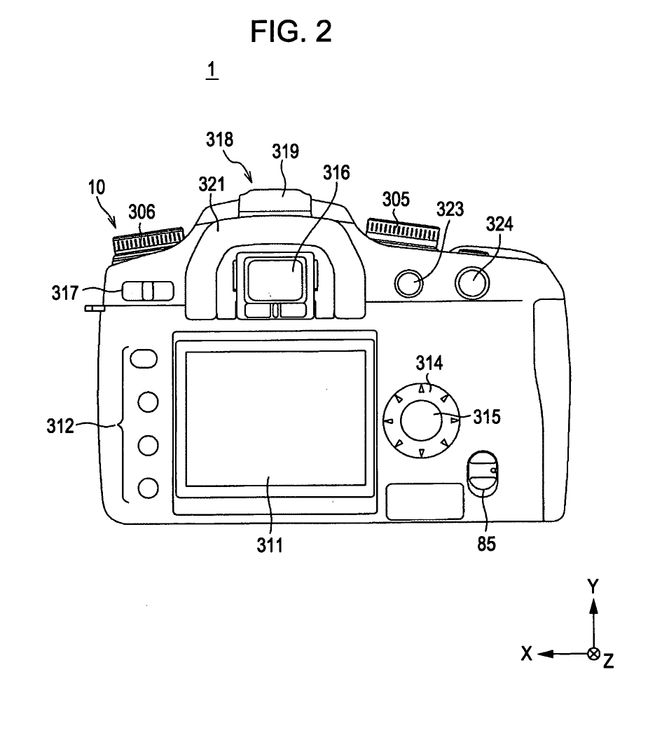

FIGS. 1 and 2 show the external configuration of an imaging apparatus 1 according to an embodiment of the present invention. FIG. 1 is a front view, and FIG. 2 is a rear view.

The imaging apparatus 1 is configured as a single-lens reflex digital still camera, for example, and includes a camera body 10 and an interchangeable lens 2 serving as an imaging lens removable from the camera body 10.

Referring to FIG. 1, the camera body 10 has the following elements on its front side: a mounting 301 provided substantially in the front center and on which the interchangeable lens 2 is mounted, a lens change button 302 provided on the right side of the mounting 301, a grip 303 at which the camera body 10 can be gripped, a mode setting dial 305 provided at the front upper left, a parameter setting dial 306 provided at the front upper right, and a shutter button 307 provided at the top of the grip 303.

Referring to FIG. 2, the camera body 10 has the following elements on its rear side: a liquid crystal display (LCD) 311, setting buttons 312 provided on the left side of the LCD 311, a directional keypad 314 provided on the right side of the LCD 311, a push button 315 provided in the center of the directional keypad 314, an optical finder 316 provided on the upper side of the LCD 311, an eyecup 321 surrounding the optical finder 316, a main switch 317 provided on the left side of the optical finder 316, an exposure correction button 323 and an autoexposure (AE) lock button 324 both provided on the right side of the optical finder 316, and a flash 318 and a connection terminal 319 both provided on the upper side of the optical finder 316.

The mounting 301 has a connector and a coupler that provide electrical and mechanical connections, respectively, to the interchangeable lens 2 mounted thereon.

The lens change button 302 can be pressed down, whereby the interchangeable lens 2 mounted on the mounting 301 can be removed.

The imaging apparatus 1 is gripped at the grip 303 by a user when the user shoots an image. The grip 303 has a curved surface so that the user's fingers can be fitted thereto well. A battery housing and a card housing (both not shown) are provided inside the grip 303. The battery housing houses a battery as a power source of the imaging apparatus 1. A memory card in which data of a shot image is recorded can be put into and removed from the card housing. The grip 303 may also be provided with a grip sensor that detects whether or not the grip 303 is gripped by the user.

The mode setting dial 305 and the parameter setting dial 306 have substantially a disk-like shape and are rotatable within a plane substantially parallel to the top surface of the camera body 10. The mode setting dial 305 is used for selecting a mode or a function from various modes and functions of the imaging apparatus 1, such as control modes including an AE control mode and an AF control mode, shooting modes including a still image shooting mode in which a single still image is shot and a continuous shooting mode in which images are shot continuously, a reproduction mode in which a recorded image is reproduced, and so forth. The parameter setting dial 306 is used for setting parameters of such functions of the imaging apparatus 1.

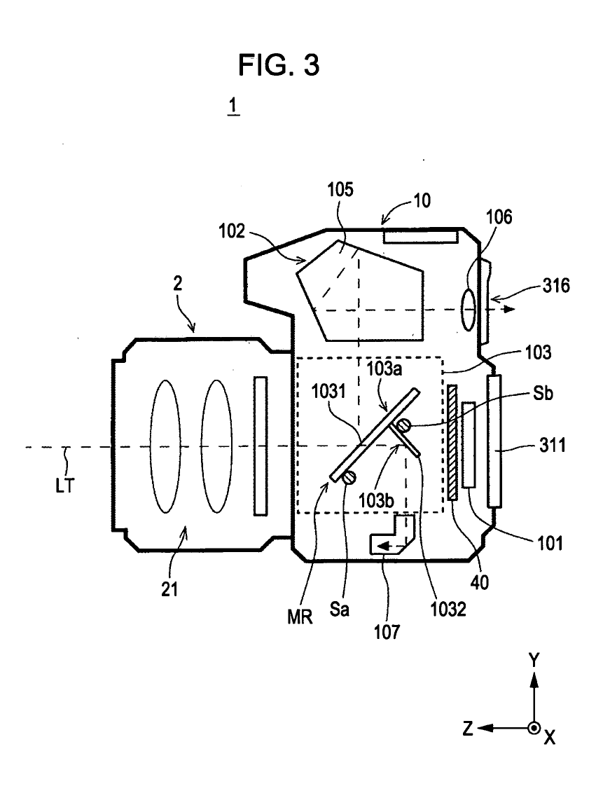

The shutter button 307 is a press switch that can be pressed down halfway and all the way. When the shutter button 307 is pressed down halfway in the still image shooting mode, a preparatory operation for shooting a still image of an object (preparations including exposure parameter setting and focus detection) is performed. When the shutter button 307 is pressed down all the way, a shooting operation (a series of operations including exposure of an imaging device 101 (see FIG. 3), predetermined image processing of an image signal obtained thereby, and recording of data resulting therefrom into a memory card or the like) is performed.

The LCD 311, which has a color liquid crystal panel capable of displaying an image, displays an image taken by the imaging device 101 (see FIG. 3) and reproduces a recorded image, for example. The LCD 311 also displays a setting screen in which the functions and modes of the imaging apparatus 1 are set. The LCD 311 may be replaced with an organic electroluminescent (EL) or plasma display.

The setting buttons 312 are used for operations of various functions of the imaging apparatus 1. The setting buttons 312 include a selection set switch with which an item selected in a menu screen displayed on the LCD 311 is set, a selection cancel switch, a menu display switch with which the contents of the menu screen are changed, a display on/off switch, and a display enlargement switch, for example.

The directional keypad 314 includes an annular member having a plurality of press points (indicated by triangular marks in FIG. 2) radially defined at regular intervals, and a plurality of contact points (switches, not shown) provided in correspondence with the press points. The contact points detect whether or not the respective press points are pressed. The push button 315 is disposed in the center of the directional keypad 314. The directional keypad 314 and the push button 315 are used for inputting instructions such as change of the magnification (change of the zoom lens position to a wide-angle end or a telephoto end), frame advancement of recorded images to be reproduced on the LCD 311 or the like, and setting of shooting conditions (the f-number, the shutter speed, use or non-use of the flash).

The optical finder 316 optically displays the range in which an object is shot. Specifically, an image of an object is introduced through the interchangeable lens 2 to the optical finder 316, through which the user can view the actual object whose image is to be taken by the imaging device 101.

The main switch 317 is a sliding switch that slides laterally between two contact points. The power of the imaging apparatus 1 is turned on by sliding the main switch 317 to the left, and is turned off by sliding the main switch 317 to the right.

The flash 318 is configured as a built-in pop-up flash. An external flash or the like can be connected to the camera body 10 via the connection terminal 319.

The eyecup 321, having a U shape, has a light-shielding characteristic and serves as a light-shielding member that prevents external light from entering the optical finder 316.

The exposure correction button 323 is used for manually adjusting the exposure value (including the f-number and the shutter speed). The AE lock button 324 is used for fixing the exposure value.

The interchangeable lens 2 serves as a lens window through which light from an object (an optical image) is taken, and also serves as an image taking optical system through which the light from the object is guided to the imaging device 101 disposed inside the camera body 10. The interchangeable lens 2 can be removed from the camera body 10 by pressing the lens change button 302.

The interchangeable lens 2 includes a lens unit 21 (see FIG. 3) constituted by a plurality of lenses that are arranged in series along an optical axis LT. The lens unit 21 includes a focus lens with which the focus is adjusted and a zoom lens with which the magnification is changed. Focus adjustment and magnification change are performed by moving the focus lens and the zoom lens, respectively, along the optical axis LT (see FIG. 3). The interchangeable lens 2 also has at an appropriate position on the outer periphery of the lens barrel thereof an operation ring rotatable along the outer periphery of the lens barrel. The zoom lens is manually or automatically moved along the optical axis LT to various positions in accordance with the rotating direction and the amount of rotation of the operation ring, whereby a zoom ratio (the magnification for image shooting) can be set in accordance with the position of the zoom lens.

### Internal Configuration of Imaging Apparatus 1

Next, the internal configuration of the imaging apparatus 1 will be described. FIG. 3 is a longitudinal sectional view of the imaging apparatus 1. Referring to FIG. 3, the camera body 10 houses the imaging device 101, a finder unit (finder optical system) 102, a mirror box (mirror moving device) 103, a phase difference AF module 107, and so forth. In FIG. 3, as a matter of convenience, a main-mirror holder 1031 and a sub-mirror holder 1032, which will be described separately below, are simply illustrated.

The imaging device 101 is disposed on and perpendicularly to the optical axis LT of the lens unit included in the interchangeable lens 2 in a state where the interchangeable lens 2 is mounted on the camera body 10. The imaging device 101 is, for example, a complementary-metal-oxide-semiconductor (CMOS) color area sensor (a CMOS imaging device) in which a plurality of pixels including photodiodes are arranged in a two-dimensional matrix. The imaging device 101 generates analog electrical signals (image signals) for respective color components of red (R), green (G), and blue (B) contained in the object light introduced through the interchangeable lens 2 to the imaging device 101, and outputs the electrical signals as image signals for the respective colors of R, G, and B.

The mirror box 103 (shown as dashed lines) is secured to the camera body 10 at such a position on the optical axis LT that the mirror box 103 can reflect the object light toward the finder unit 102. The object light that has passed through the interchangeable lens 2 is reflected in the upward direction by a main mirror 103a, described separately below, provided in the mirror box 103. Part of the object light that has passed through the interchangeable lens 2 is transmitted through the main mirror 103a.

The finder unit 102 includes a pentaprism 105, an eyepiece lens 106, and the optical finder 316. The pentaprism 105 has a pentagonal cross-section. The optical image of an object enters the pentaprism 105 from the bottom thereof, and is reflected thereinside so as to be turned upside down and flipped horizontally. Thus, the optical image becomes an erect image. The eyepiece lens 106 guides the image of the object that has been erected by the pentaprism 105 to the outside of the optical finder 316. With such a configuration, in a waiting state before shooting is performed, the finder unit 102 serves as a finder through which the field to be shot can be checked.

The mirror box 103 houses a mirror unit MR including the main-mirror holder 1031 and the sub-mirror holder 1032 holding the main mirror 103a and a sub-mirror 103b, respectively. The mirror unit MR is movably provided in the mirror box 103. The mirror unit MR can be in a position, shown in FIG. 3, in which the sub-mirror 103b provided at the back of the main-mirror holder 1031 leans against the back surface of the main-mirror holder 1031. In the position shown in FIG. 3 (hereinafter also referred to as the “mirror-down position”), part of the object light transmitted through the main mirror 103a is reflected by the sub-mirror 103b, and enters the phase difference AF module 107. To cause the object light reflected by the sub-mirror 103b to accurately enter the phase difference AF module 107, a stopper (positioning member) Sb that positions the sub-mirror 103b so as to be in the mirror-down position by being in contact with a predetermined region (specifically, a magnet plate PM described separately below) of the sub-mirror holder 1032 is provided in the mirror box 103. Likewise, a stopper Sa that positions the main-mirror holder 1031 so as to be in the mirror-down position is also provided in and secured to the mirror box 103.

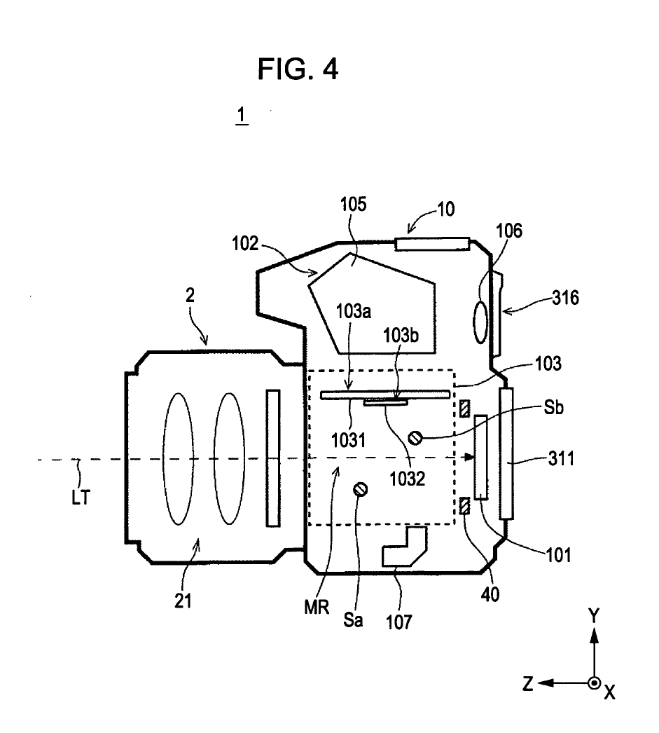

The mirror unit MR serves as a so-called quick return mirror used for changing the optical path of the imaging apparatus 1. At the time of exposure (shooting), the mirror unit MR changes its orientation by being folded in such a manner that the sub-mirror 103b and the main mirror 103a become substantially parallel to each other as shown in FIG. 4, thereby being positioned at the top of the mirror box 103 (this position is hereinafter also referred to as the “mirror-up position”). In changing the orientation of the mirror unit MR from the mirror-down position (shown in FIG. 3) to the mirror-up position, the mirror unit MR is swung back by a four-bar linkage mechanism, such as a technique disclosed in Japanese Unexamined Patent Application Publication No. 58-126522, which will be separately described in detail below. With the mirror unit MR in the mirror-up position, the object light introduced through the interchangeable lens 2 can reach the imaging device 101 without being blocked by the mirror unit MR, whereby the imaging device 101 is exposed. When imaging performed by the imaging device 101 is finished, the mirror unit MR returns to the original position (the mirror-down position shown in FIG. 3).

By positioning the mirror unit MR so as to be in the mirror-up position shown in FIG. 4 before shooting (shooting for image recording) is performed, the imaging apparatus 1 is capable of live view (preview) display in which object images formed in accordance with image signals sequentially generated by the imaging device 101 are displayed on the LCD 311 as a moving image. Therefore, in the imaging apparatus 1 in a state before shooting is performed, whether to use the electronic finder (i.e., the LCD 311, used in the live view mode) with which the live view display is performed or the optical finder 316 can be selected, and subsequently the layout of the object can be determined. Switching between the electronic finder and the optical finder 316 is performed by using a switching button 85 shown in FIG. 2.

The phase difference AF module 107 serves as a focus detection sensor configured to detect the focus for an object by receiving the object light reflected by the sub-mirror 103b in the mirror-down position. The phase difference AF module 107 is disposed below the mirror box 103 and detects the in-focus position by performing focus detection (hereinafter also referred to as “phase difference AF”) in accordance with a phase difference detection method.

A shutter unit 40 is disposed on the optical axis LT in front of the imaging device 101. The shutter unit 40 includes a screen that is vertically openable and closable. Thus, the shutter unit 40 serves as a mechanical focal plane shutter that opens and blocks the optical path of the object light guided along the optical axis LT toward the imaging device 101. The shutter unit 40 may be omitted if the imaging device 101 has a complete electronic shutter function.

### Major Elements in Mirror Box 103

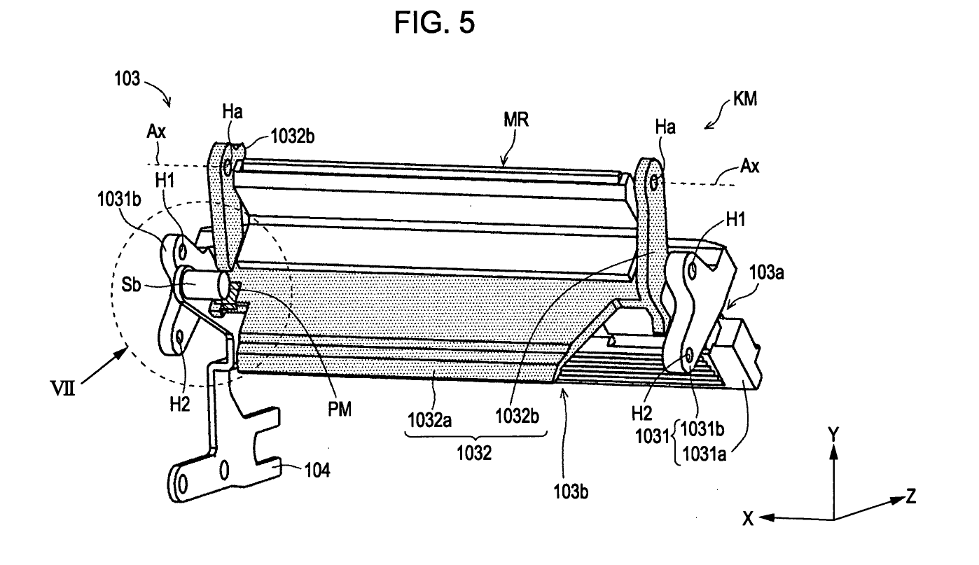

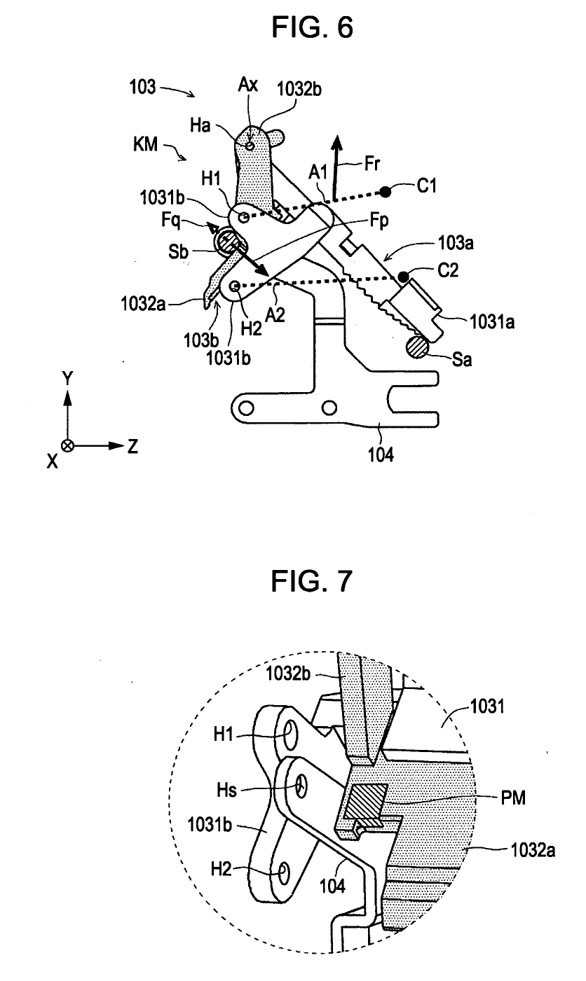

FIGS. 5 and 6 are a perspective view and a side view showing major elements housed in the mirror box 103, showing the mirror unit MR in the mirror-down position and elements provided therearound. FIG. 7 is an enlarged view of a part enclosed by a dashed-line circle VII in FIG. 5. FIG. 7 shows a state where the stopper Sb is removed from a fitting hole Hs.

As described above, the mirror unit MR includes the main-mirror holder 1031 and the sub-mirror holder 1032 (the hatched parts in FIGS. 5 to 7).

The main-mirror holder 1031 includes a body 1031a configured to hold the main mirror 103a, and two arms 1031b having a Y shape (see FIG. 6) and connected to the respective sides of the body 1031a.

The two arms 1031b each have at two branched tips thereof holes H1 and H2. Referring to FIG. 6, one end of a movable arm A1 (shown as a dashed line) is rotatably fitted to the hole H1, with the other end thereof secured to the mirror box 103. The movable arm A1 is pivotable about the other end acting as a fulcrum C1, i.e., about the X axis. Likewise, one end of a support arm A2 (shown as a dashed line) is rotatably fitted to the hole H2, with the other end thereof secured to the mirror box 103. The support arm A2 is pivotable about the other end acting as a fulcrum C2, i.e., about the X axis. In such a four-bar linkage mechanism, when, for example, an upward motive force Fr (see FIG. 6) produced by a restoring force of a coil spring connected to the movable arm A1 is applied to the movable arm A1, the main-mirror holder 1031 is swung back, thereby being moved so as to be in the mirror-up position shown in FIG. 4. In contrast, when a downward motive force is applied to the movable arm A1 with the main-mirror holder 1031 being in the mirror-up position, the main-mirror holder 1031 can be moved so as to be in the mirror-down position shown in FIG. 6. When the main-mirror holder 1031 is in the mirror-down position, the main-mirror holder 1031 is in contact with the stopper Sa, which has a cylindrical shape, whereby the main mirror 103a can be angled at 45 degrees, for example, with respect to the vertical direction.

The sub-mirror holder 1032 serves as a movable member holding the sub-mirror 103b, and includes a body 1032a having a plate-like shape and holding the sub-mirror 103b, and two arms 1032b connected to the respective sides of the body 1032a.

The two arms 1032b have at the tips thereof holes Ha, respectively. The sub-mirror holder 1032 is turnable about rotational shafts Ax fitted to the holes Ha and extending parallel to the X axis, with the two holes Ha as the fulcrum. With such a mechanism KM that moves the sub-mirror holder 1032, the orientation of the sub-mirror 103b can be changed between the mirror-down position (a first position) shown in FIGS. 5 and 6 and the mirror-up position (a second position) shown in FIG. 4, in combination with the change of the orientation of the main-mirror holder 1031 moved by the movable arm A1.

When the sub-mirror holder 1032 in the mirror-up position is moved so as to be in the mirror-down position, the sub-mirror holder 1032 comes into contact with the stopper Sb, which has a cylindrical shape, whereby the sub-mirror 103b can be oriented so as to be tilted at a predetermined angle (45 degrees, for example) with respect to the vertical direction. The stopper Sb is made of magnetic stainless steel defined as any of SUS400 series according to the Japanese Industrial Standards (JIS), specifically, ferritic stainless steel defined as SUS430, and is attached to the tip of a support member 104 secured to the mirror box 103.

When the mirror unit MR, configured as described above, in the mirror-up position is moved so as to be in the mirror-down position, the sub-mirror holder 1032 bumps into the stopper Sb at a relatively high speed, producing a rebound. The rebound makes the sub-mirror holder 1032 bounce off the stopper Sb, causing the sub-mirror 103b to vibrate slightly. Such a slight vibration of the sub-mirror 103b vibrates the object light reflected by the sub-mirror 103b. Therefore, the object light is not made to be correctly incident on the phase difference AF module 107, making focus detection by the phase difference AF module 107 difficult. Particularly in the continuous shooting mode, unless the phase difference AF module 107 finishes the focus detection of one frame, shooting of the subsequent frame is not started. Accordingly, if the sub-mirror 103b continues to vibrate for a long time, the speed of continuous shooting is reduced.

To avoid this, referring to FIG. 7, the sub-mirror holder 1032 of the embodiment has a rectangular magnet plate (magnetic body) PM that is magnetized as a permanent magnet on a region of the sub-mirror holder 1032 with which the stopper Sb, as a magnetic body, is to be in contact. With the magnet plate PM provided on the sub-mirror holder 1032, even if the sub-mirror holder 1032 bumps into the stopper Sb when the sub-mirror holder 1032 is moved so as to be in the mirror-down position, the slight vibration of the sub-mirror holder 1032 can be stopped in a short time because of the magnetic attraction occurring between the magnet plate PM and the stopper Sb, which is made of metal.

However, to move the sub-mirror 103b in the mirror-down position, in which the stopper Sb is attracted to the magnet plate PM, so as to be in the mirror-up position, it is important that a magnetic attraction Fq acting between the magnet plate PM and the stopper Sb when the sub-mirror 103b is in the mirror-down position shown in FIG. 6 is smaller than the motive force Fp acting on the magnet plate PM when the sub-mirror 103b in the mirror-down position is moved so as to be in the mirror-up position by applying the motive force Fr to the movable arm A1. In short, it is important to select such materials, shapes, and so forth of the magnet plate PM and the stopper Sb that the magnetic attraction Fq becomes smaller than the motive force Fp. For example, in the embodiment, the stopper Sb that is to be brought into contact with the magnet plate PM has a cylindrical surface, i.e., a curved surface having a certain curvature, and the magnet plate PM that is to be in contact with the stopper Sb has a flat surface. Thus, an appropriate value is set for the magnetic attraction Fq. An advantageous effect produced by the magnet plate PM and the stopper Sb configured as described above will be described.

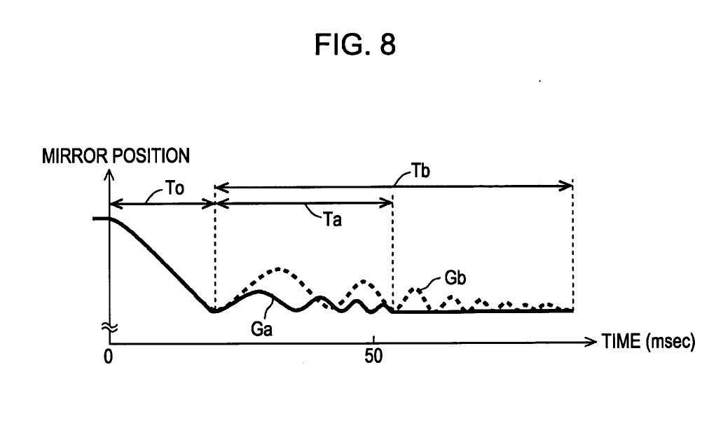

FIG. 8 is a diagram for describing the effect produced by the magnet plate PM and the stopper Sb. In FIG. 8, the horizontal axis represents time (msec) from when the sub-mirror 103b starts to be moved so as to be in the mirror-down position, and the vertical axis represents the position (the height, increasing upward in the vertical axis) of the sub-mirror 103b. Further, the movement of the sub-mirror 103b according to the embodiment is shown as a curve Ga (the solid line), and the movement of a sub-mirror according to a related-art example in which magnetic attraction is not utilized is shown as a curve Gb (the dashed line).

After a mirror-down period To in which the sub-mirror in the mirror-up position is moved so as to be in the mirror-down position, vibration of the sub-mirror due to the bumping of the sub-mirror holder into the stopper starts. In the related-art example not utilizing magnetic attraction shown as the curve Gb, there is a long period Tb in which the vibration of the sub-mirror continues before the sub-mirror is stabilized (such a period is hereinafter also referred to as the “mirror stabilization period”).

In contrast, the curve Ga of the embodiment shows that a mirror stabilization period Ta for stabilizing the sub-mirror 103b is approximately half of the mirror stabilization period Tb in the related-art example because the vibration of the sub-mirror 103b can be suppressed by the magnetic attraction occurring between the magnet plate PM provided on the sub-mirror holder 1032 and the stopper Sb.

To summarize, in the mirror box 103 of the embodiment, the magnet plate PM is provided at a region of the sub-mirror holder 1032 that is to be brought into contact with the stopper Sb, which is made of metal. With such a simple configuration, the vibration (bouncing) of the sub-mirror 103b occurring when the sub-mirror holder 1032 bumps into the stopper Sb, by which the sub-mirror 103b that is moved is positioned so as to be in the mirror-down position, can be stopped quickly. As the time for stopping the vibration of the sub-mirror 103b becomes shorter, the speed of continuous shooting in the continuous shooting mode can be made higher.

### Variations

While the mirror box 103 of the embodiment is provided in a digital camera, the mirror box 103 may be alternatively provided in a silver-halide camera (film camera).

While the stopper Sb of the embodiment is made of metal, the stopper Sb may be alternatively made of a permanent magnet. Moreover, a configuration in which a permanent magnet stopper is made to attract a metal plate, instead of the magnet plate PM, is also acceptable. Also in such a configuration, the slight vibration of the sub-mirror 103b occurring when moved so as to be in the mirror-down position can be stopped quickly.

While the stopper Sb of the embodiment has a cylindrical shape, the stopper Sb may alternatively have an oval cylindrical shape, a semicylindrical shape, or a rectangular columnar shape.

It should be understood by those skilled in the art that various modifications, combinations, sub-combinations and alterations may occur depending on design requirements and other factors insofar as they are within the scope of the appended claims or the equivalents thereof.

What is claimed is:

1. A mirror moving device having a mirror with which an optical path of an imaging apparatus is changed, the device comprising:
a movable unit provided with the mirror;
a moving mechanism capable of changing an orientation of the mirror on the movable unit between a first position and a second position; and
a positioning member configured to be in contact with a predetermined region of the movable unit when the mirror is made to be in the first position, whereby the mirror is positioned in the first position,
wherein the predetermined region and the positioning member are magnetic bodies, at least one of the predetermined region and the positioning member being magnetized as a permanent magnet, and
wherein a magnetic attraction acting between the predetermined region and the positioning member when the mirror is in the first position is smaller than a motive force acting on the predetermined region when the mirror in the first position is moved so as to be in the second position.

2. The mirror moving device according to claim 1,
wherein the positioning member has a curved surface with a predetermined curvature, and
wherein the predetermined region has a planar surface.

3. The mirror moving device according to claim 1, wherein the imaging apparatus includes a focus detection sensor configured to detect a focus for an object by receiving light from the object reflected by the mirror in the first position.

4. An imaging apparatus comprising:
a movable unit provided with a mirror with which an optical path is changed;
a moving mechanism capable of changing an orientation of the mirror on the movable unit between a first position and a second position; and
a positioning member configured to be in contact with a predetermined region of the movable unit when the mirror is made to be in the first position, whereby the mirror is positioned in the first position,
wherein the predetermined region and the positioning member are magnetic bodies, at least one of the predetermined region and the positioning member being magnetized as a permanent magnet, and
wherein a magnetic attraction acting between the predetermined region and the positioning member when the mirror is in the first position is smaller than a motive force acting on the predetermined region when the mirror in the first position is moved so as to be in the second position.
